(19) United States
(12) Patent Application Publication
(10) Pub. No.: US 2017/0072263 A1
(43) Pub. Date: Mar. 16, 2017

(54) ACTIVITY TRACKING ARRANGEMENT AND ASSOCIATED DISPLAY WITH GOAL-BASED DASHBOARD

(71) Applicant: Under Armour, Inc., Baltimore, MD (US)

(72) Inventors: Scott Laing, Austin, TX (US); Brian Carden, Austin, TX (US); Daniel Townson, Austin, TX (US); J. Parker Byrd, Austin, TX (US); Marissa Dessanti, Austin, TX (US); Marcus Piña, Austin, TX (US); Andrew Moore, Austin, TX (US)

(21) Appl. No.: 14/853,221

(22) Filed: Sep. 14, 2015

(51) Int. Cl. A63B 24/00; G09B 5/02; G09B 19/00

(52) U.S. Cl. CPC A63B 24/0062; G09B 19/0038; G09B 5/02

(57) ABSTRACT

An activity tracking arrangement is configured to provide activity data to a user. The activity tracking arrangement includes a sensor device and an associated display device. The sensor device is configured to be carried by the user and includes at least one sensor configured to obtain activity data associated with at least one of a plurality of personal metrics for the user. The display device is configured to receive the activity data obtained by the sensor device and display the activity data obtained by the sensor device in sector form on a display screen. Each of the plurality of personal metrics is associated with one of a plurality of sectors on the display screen. Each of the plurality of sectors includes a first area associated with progress toward a goal for the associated personal metric and a second area associated with remaining requirements to reach the goal for the associated personal metric.

### FIELD

This document relates to the field activity tracking devices, and particularly to devices configured to collect and display motion, activity, and sleep information for a user.

### BACKGROUND

Activity tracking devices are increasingly utilized by individuals interested in tracking metrics related to their personal health and fitness. These activity tracking devices include, for example, heart rate monitors, step counters, stair counters, global positioning system (“GPS”) tracking devices, as well as various other motion and biometric tracking devices. The popularity and increasing use of activity trackers creating vast amounts of data coming from disparate sources over long periods of time. Because of the vast amounts of data collected over long periods of time, it is often difficult to present the data to the user in a logical easy-to-comprehend form.

Various display arrangements have been implemented in past devices which present data to the user in a summarized format. Presentation of activity data in raw numerical form or a chart format is common with such devices. For example, a total number of steps for a given day may be presented to a user on a screen. The user may also be provided with a breakdown of steps over a given period of time (e.g., steps per hour for the past day, steps per day for the past week, etc.). While this information may be desired by the user, it is often difficult for the user to quickly obtain a concise summary of multiple personal metrics for a given period of time. For example, a user who has arrived at a display of step data for a given day may have some difficulty in maneuvering through the dashboard of the activity tracking device to find a display of calorie information for the same.

In view of the foregoing, it would be advantageous to provide an activity tracking device having a display that is configured to show a concise summary of numerous activity-related parameters for a given period of time. It would also be advantageous if the display were configured to express the activity data in relation to goals of the user. Moreover, it would be advantageous if the display included an intuitive dashboard that allowed the user to obtain additional more detailed data in quick and convenient manner.

### SUMMARY

In accordance with one exemplary embodiment of the disclosure, there is provided an activity tracking arrangement configured to provide activity data to a user. The activity tracking arrangement includes a sensor device and an associated display device. The sensor device is configured to be carried by the user and includes at least one sensor configured to obtain activity data associated with at least one of a plurality of personal metrics for the user. The display device includes a display screen. The display device is configured to receive the activity data obtained by the sensor device and display the activity data obtained by the sensor device in sector form on the display screen. Each of the plurality of personal metrics is associated with one of a plurality of sectors on the display screen. Each of the plurality of sectors includes a first area associated with progress toward a goal for the associated personal metric and a second area associated with remaining requirements to reach the goal for the associated personal metric.

Pursuant to another exemplary embodiment of the disclosure, there is disclosed a computer readable medium containing instructions for controlling a display device by receiving activity data from a sensor device carried by a user, the activity data associated with at least one of a plurality of personal metrics. The computer readable medium also contains instructions for processing the activity data received from the sensor device for presentation on a display screen in sector form. Furthermore, the computer readable medium contains instructions for displaying the activity data received from the sensor device in sector form on the display screen, wherein each of the plurality of personal metrics is associated with one of a plurality of sectors on the display screen, and wherein each of the plurality of sectors includes a first area associated with progress toward a goal for the associated personal metric and a second area associated with remaining requirements to reach the goal for the associated personal metric.

In accordance with another exemplary embodiment of the disclosure, a method is disclosed for providing activity data to a user. The method comprises receiving activity data from a sensor device carried by a user, the activity data associated with at least one of a plurality of personal metrics. The method further comprises processing the activity data received from the sensor device for presentation on a display screen in sector form. Additionally, the method comprise displaying the activity data received from the sensor device in sector form on the display screen, wherein each of the plurality of personal metrics is associated with one of a plurality of sectors on the display screen. Each of the plurality of sectors includes a first area associated with progress toward a goal for the associated personal metric and a second area associated with remaining requirements to reach the goal for the associated personal metric.

The above described features and advantages, as well as others, will become more readily apparent to those of ordinary skill in the art by reference to the following detailed description and accompanying drawings. While it would be desirable to provide an activity tracking device and associated display that provides one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

FIG. 1 shows an exemplary embodiment of an activity tracking system including a sensor device and a display device;

FIG. 2 shows electronic components in the sensor device and the display device of the activity tracking system of FIG. 1;

FIG. 3A shows a front view of the display device of FIG. 1 including a dashboard screen provided on the display device, the dashboard screen including activity data obtained by the sensor device provided in sector form;

FIG. 3B shows an elongated view of the dashboard screen of FIG. 3A;

FIG. 4 shows a front view of the dashboard screen of FIG. 3A including a subjective health perception scale;

FIG. 5 shows a front view of the dashboard screen of FIG. 3A including a heart rate report;

FIG. 6 shows a front view of the of the dashboard screen of FIG. 3A including a vital statistics report;

FIG. 7 shows a front view of the of the dashboard screen of FIG. 3A including a trends report;

FIG. 8A shows a front view of the display device of FIG. 1 including an activity detail screen;

FIG. 8B shows an elongated view of the activity detail screen of FIG. 8A;

FIG. 9A shows a front view of the display device of FIG. 1 including a workout detail screen;

FIG. 9B shows an elongated view of the workout detail screen of FIG. 5A;

FIG. 10A shows a front view of the display device of FIG. 1 including a sleep detail screen;

FIG. 10B shows an elongated view of the sleep detail screen of FIG. 10A;

FIG. 11A shows a front view of the display device of FIG. 1 including an nutrition detail screen;

FIG. 11B shows an elongated view of the nutrition detail screen of FIG. 11A;

FIG. 12 shows an alternative embodiment of the nutrition detail screen of FIG. 11A;

FIG. 13A shows a front view of the display device of FIG. 1 including a weight detail screen;

FIG. 13B shows an elongated view of the weight detail screen of FIG. 13A;

FIG. 14A shows an alternative embodiment of the dashboard screen of FIG. 3A including a logo;

FIG. 14B shows a the dashboard screen of FIG. 14A with the logo transitioned to a weight icon;

FIG. 15 shows an alternative embodiment of the dashboard screen of FIG. 3A; and

FIG. 16 shows a method for providing activity data to a user using the activity tracking system of FIG. 1.

### DESCRIPTION

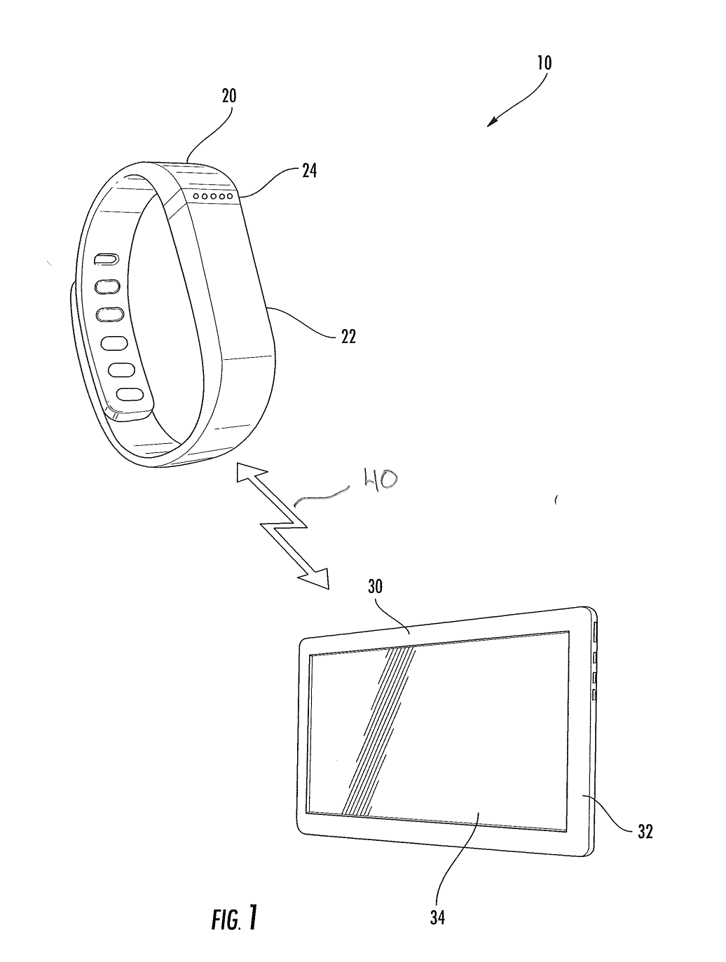

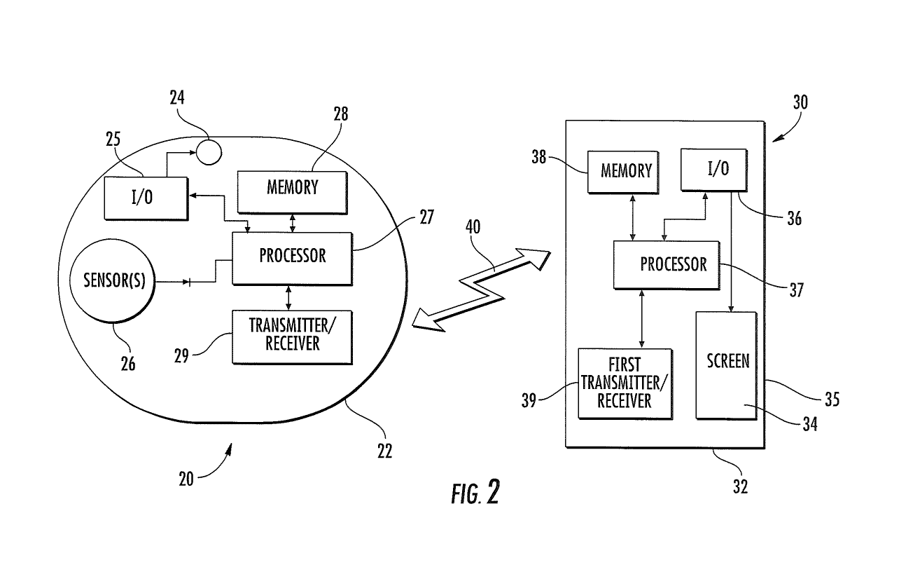

With reference to FIGS. 1-2, an exemplary embodiment of an activity tracking system 10 includes at least one activity sensor device 20 and an associated electronic display device 30. The activity sensor device 20 is designed and dimensioned to be worn on or carried by the body of a user and collect activity information about the user. The activity sensor device 20 is in communication with the electronic display device 30, and is configured to deliver the collected activity data about the user to the electronic display device 30. The electronic display device 30 is designed to process the activity data and display the collected information to the user in a format that shows context for daily exercise, general activity, and sleep behavior.

Sensor Device

The activity sensor device 20 (which may also be referred to herein as a “sensor device”) may be provide in any of various forms and is configured to collect any of various types of activity data related to a user. Such activity data may be, in particular, human kinematic and/or physiological data that provides personal metrics information about a level of activity during awake times and sleep quality during sleep times. For example, the sensor device 20 may be configured to collect one or more of step data, body motion data, distance traversal data, altitude data, heart rate data, body temperature data, breathing data, environmental/positional data (such that provided by a GPS receiver), or any of various other types of personal metrics that may be relevant to determining awake time activities or sleep quality of the user. Accordingly, the term “activity data” as used herein refers to data associated the user during the user's wake time or sleep time, and such data may indicate the user's participation in any of various activities including high intensity activity, sedentary activity, or various degrees of activity in-between. Activity data may be collected by the user manually, collected by sensor device, or collected by any of various other means. The term “personal metric” as used herein refers to any of various measures of activity data that may be defined by any of various activity parameters (e.g., user heart rate expressed as beats per minute, user activity defined by total steps for a day, distance traversed for some time period, calories spent, or total time of activity, sleep defined by sleep time or sleep quality/sleep cycles, etc.). In at least one embodiment, the sensor device 20 may be an activity tracker configured to measure one or more of steps taken (including walking or running), distance traversed, stairs climbed, heart rate, as well as various other personal metrics (such “activity trackers” are commonly also referred to as “fitness trackers”). These activity trackers may further process the measured parameter to determine other personal metrics such as calories spent, sleep quality, etc. Such further processing may occur on the activity tracker itself or in association with other computer devices in communication with the activity tracker. Examples of activity trackers include those sold under the trademarks FITBIT®, JAWBONE®, POLAR® and UNDER ARMOUR®.

The sensor device 20 is configured to be worn or carried by the human user. For example, in the embodiment shown in FIG. 1, the sensor device 20 is provided as a wrist band that the user straps to his or her wrist. However, it will be recognized that in other embodiments, the sensor device 20 may be provided in any of various different configurations to be worn on any of various locations on the body of the user, such as a module that clips on to clothing, is worn on a chest strap, fits in a pocket of the user, or is worn in any of various alternative locations and provided in any of various forms. Additional examples of configurations for the sensor device 20 include configurations where the sensor device is provided as a component of a multi-function device, such as a watch, a mobile phone or other personal electronics device. In the embodiment disclosed herein, the sensor device 20 is shown as being a completely separate unit from the display device 30. However, in at least one embodiment, the sensor device 20 and the display device 30 are provided as a single unit. For example, the sensor device 20 and the display device 30 may be provided as part of a mobile phone or other personal electronics device. While a single sensor device 20 is shown in the embodiment of FIG. 1, it will be recognized that multiple sensor devices may be used by a single user, each of the sensor devices 20 configured for communication with the electronic display device 30.

With continued reference to the embodiment of FIGS. 1 and 2, the sensor device 20 includes a protective outer shell or housing 22 designed to retain and protect various sensors and other electronic components positioned within the housing 22. The housing 22 may be provided in various forms. In at least one embodiment, the housing 22 includes a relatively rigid portion that securely retains the electronic components and a more resilient portion as an outer layer that provides shock absorption features in the event the sensor device 20 is dropped by the user. The sensor device 20 and housing 22 may be configured to be worn or otherwise carried by the user in any of a number of ways. For example, the housing 22 of the sensor device 20 may be provided as part of a chest or wrist strap having an associated clasp, or may include a clip or other arrangement that allows the sensor device 20 to be coupled to the clothing of the user.

The sensor device 20 may also include other features visible on the housing 22 such as an I/O interface 25, which may include a display 24, one or more connection ports (not shown), or other input and output hardware and software. The display 24 may vary based on the type of device. For example, in one embodiment the display 24 may simply be one or more lights configured to communicate information to the user (e.g., progress towards a goal). In another embodiment, the display 24 may be an LCD or LED screen that provides more specific information to the user (e.g., total number of steps for the day). The connection ports may be used to connect the sensor device 20 to a power source or to share data with other electronic devices.

As shown in FIG. 2, the sensor device 20 includes electronic circuitry comprising one or more sensors 26, a processor 27, a memory 28, and a transceiver 29. The sensor device 20 also includes a battery (not shown) configured to power the various electronics devices within the sensor device 20. In at least one embodiment, the battery of the sensor device 20 is a rechargeable battery. In this embodiment, the sensor device 20 may be placed in or connected to a battery charger configured for use with the sensor module in order to recharge the battery.

The sensors 26 may be provided any of various devices configured to collect the activity data, including step data, motion data, distance traversal data, altitude data, heart rate data, body temperature data, breathing data, environmental/positional data, or any of various other types of personal metrics that may be relevant to determining activities of the wearer. In at least one embodiment, the sensor is a 3-axis accelerometer configured to detect the steps of the wearer during walking and running, and general movements of the wearer during more sedentary periods such as sleep. Of course, it will be recognized by those of ordinary skill in the art that numerous other sensors may be used, depending on the type of activity the sensor device 20 is designed to detect.

With continued reference to FIG. 2, the processor 27 may be any of various microprocessors as will be recognized by those of ordinary skill in the art. The processor 27 is configured to receive signals related to receive activity data from the sensors 26 and process such signals. The processor 27 is connected to the memory 28 and the transceiver 29, and may deliver received activity data to one or both of the memory 28 and the transceiver 29. Additionally, the processor 27 may perform some processing on the received activity data prior to delivery to the memory 28 or transceiver 29. For example, the processor 27 may associate the received activity data with a particular time, day and/or event. The processor 27 is also connected to the I/O interface 25, and may send signals to the I/O interface 25 which results in illumination of the display 24.

The memory 28 is configured to store information, including activity data that may be retrieved, manipulated or stored by the processor 27, as well as software for execution by the processor 27. The memory 28 may be of any type capable of storing information accessible by the processor 27, such as a memory card, ROM, RAM, write-capable, read-only memories, or other computer-readable medium. The data may be stored in the memory 28 in a relational database as a table having a plurality of different fields and records, XML documents, or flat files. The data may also be formatted in any computer-readable format such as, but not limited to, binary values, ASCII or Unicode.

The transceiver 29 is an RF transmitter and receiver configured to transmit and receive communications signals over a short range using a wireless communications technology, such as Bluetooth®, using any of various communications protocols, such as TCP/IP. Such transceivers are well known and will be recognized by those of ordinary skill in the art. The transceiver 29 is particularly configured to communicate with the display device 30 when the sensor device 20 is within range of the display device 30, and transmit activity data to the display device.

While the sensor device 20 has been described herein as the primary device for collecting and transmitting activity data to the display device 30, it will be recognized that activity data may also be collected and input in to the display device in different ways. In at least one embodiment, the user may manually collect activity data and manually input the collected activity data into the display device 30. For example, the user may manually collect sleep data or calorie consumption data and input such activity data into the display device without the use of a sensor device or other device transmitting the activity data to the display device.

Display Device

With continued reference to FIG. 2, in at least one embodiment, the display device 30 is a handheld computing device. In this embodiment, the display device 30 includes an input/output interface 36, a processor 37, a memory 38, and a transceiver 39. While a tablet computer has been shown as the display device 30 in FIGS. 1 and 2, it will be appreciated that the display device 30 may be provided in other forms in addition to or in lieu of the tablet computer. For example, the display device 30 may be a standalone device, such as a desktop PC or smart television. Alternatively, the display device may be another type of portable or handheld computing device such as a watch, smartphone, laptop computer, or any of various other mobile computing devices. As will be recognized by those of ordinary skill in the art, the components of the display device 30 may vary depending on the type of display device used. Such alternative display devices may include much of the same functionality and components as the display device 30 shown in FIGS. 1 and 2, but may not include all the same functionality or components.

The display device 30 includes a protective outer shell or housing 32 designed to retain and protects the electronic components positioned within the housing 32. The housing 32 may be provided in various forms. In at least one embodiment, the housing 32 includes a relatively rigid portion that securely retains the electronic components and a more resilient portion as an outer layer that provides shock absorption features in the event the sensor device 20 is dropped by the user.

With continued reference to FIG. 2, the I/O interface 36 of the display device 30 includes software and hardware configured to facilitate communications with the sensor device 20 carried by the user. The hardware includes a display screen 34 configured to visually display graphics, text and other data to the user. In particular, the display screen 34 of the I/O interface 36 is configured to display activity data received from the sensor device 20. The hardware also may also include a microphone and speakers to facilitate audio communications with the user. In at least one embodiment, the display screen 34 is a touch screen display that allows the user to see data presented on the display screen 34 and input data into the display device 30 via a keyboard on the touch screen.

It will be recognized that the sensor device 20 and the display device 30 may be provided as part of an activity tracking system 10 that makes use of various communications infrastructures and systems, such as the mobile telephony network, the internet, and the global positioning system (GPS). An example of such an activity tracking system is described in U.S. patent application Ser. No. 14/796,196, filed Jul. 10, 2015, the content of which is incorporated herein by reference in its entirety.

The processor 37 of the display device 30 may be any of various processors as will be recognized by those of ordinary skill in the art. The processor 37 is connected to the I/O interface 36, the memory 38, and the transceiver 39, and is configured to deliver data to and receive data from each of these components. In at least one embodiment, the processor 37 is configured to process raw activity data received from the sensor device 20 and transform the activity data into a graphical format for presentation on the display screen 34. It will be recognized by those of ordinary skill in the art that a “processor” includes any hardware system, hardware mechanism or hardware component that processes data, signals or other information. A processor can include a system with a central processing unit, multiple processing units, dedicated circuitry for achieving functionality, or other systems.

The memory 38 is configured to store information, including data, software and firmware for execution by the processor 37. The data may be, in particular, activity data related to the activities of the user. The memory 38 may be of any type of device capable of storing information accessible by the processor, such as a memory card, ROM, RAM, write-capable memories, read-only memories, hard drives, discs, flash memory, or any of various other computer-readable medium serving as data storage devices as will be recognized by those of ordinary skill in the art.

In at least one embodiment, portions of the system and methods described herein may be implemented in suitable software code that may reside within the memory. A computer program product implementing an embodiment disclosed herein may therefore comprise one or more computer-readable storage media storing computer instructions translatable by a processor to provide an embodiment of a system or perform an embodiment of a method disclosed herein. Computer instructions may be provided by lines of code in any of various languages as will be recognized by those of ordinary skill in the art. A “computer-readable medium” may be any type of data storage medium that can store computer instructions, including, but not limited to the memory devices discussed above.

The transceiver 39 is an RF transmitter and receiver configured to transmit and receive communications signals over a short range using a wireless communications technology, such as Bluetooth®, using any of various communications protocols, such as TCP/IP. Such transceivers are well known and will be recognized by those of ordinary skill in the art. The transceiver 39 is particularly configured to communicate with the transceiver 29 of the sensor device 20. The display device 30 also includes a battery (not shown) configured to power the transceiver 39 and various other the electronic components within the display device 30. In at least one embodiment, the transceiver 39 is configured to allow the display device 30 to communicate with a wireless telephony network, as will be recognized by those of ordinary skill in the art. The wireless telephony network may comprise any of several known or future network types. For example, the wireless telephony network may comprise commonly used cellular phone networks using CDMA or FDMA communications schemes. Some other examples of currently known wireless telephony networks include Wi-Fi, WiMax, GSM networks, as well as various other current or future wireless telecommunications arrangements.

Raw activity data collected by the sensor device 20 may be processed by the display device 30 or delivered to a remote server for further processing. The processing to be performed may depend on various factors including the type of data received and different subscriptions of the user/athlete. Typical processing might relate to the user's current activity level, trends, history, training state, etc. For example, the computer processing the raw data may calculate an activity level based on a combination of inputs, including, for example, steps taken over a period of time, heart rate, etc. In at least one embodiment, GPS data is used to determine various athletic data points, such as the speed of the athlete calculated over different time periods, total distance travelled, or the route taken by the athlete during a sporting event. Furthermore, the activity data may be processed into different forms and formats, depending on the particular device that will ultimately be used to view the processed data. For example, the activity data may be processed into a first format that will allow it to be viewed on a watch and into a second format that will allow it to be viewed on the monitor of a personal computer. While these are but a few examples of how the raw data may be processed, those of skill in the art will recognize that nearly countless other possibilities exist for how the data received from the sensor device 20 will be processed for subsequent viewing and analysis. After the raw activity data is transmitted and processed, the processed data may then be displayed or otherwise presented on a user interface of the display device 30.

In operation, when a user carries one or more sensor devices 20, and activity data from each sensor device 20 is delivered to the display device 30. As represented by arrow 40, in FIGS. 1 and 2, the sensor device 20 is configured to transmit a wireless RF signal representative of the activity data to at least one display device 30, such as the tablet. In addition, the activity data may also be transmitted to additional computing devices, such as a watch or a laptop computer where the activity data may be conveniently displayed for the user. In other embodiments, a wired connection may exist between the display device 30 and the sensor device 20, and the activity data may be transferred over the wired connection.

In at least one embodiment, this transmission from the sensor device 20 to the display device 30 occurs automatically without the user needing to prompt the transmission. Because the transmissions are automatic, some mechanism may be used to turn on the transceiver 29 of the sensor device 20 or otherwise indicate that automatic transmissions should begin. For example, in one embodiment, an on/off switch is provided on the sensor device 20 that allows the athlete to begin automatic transmissions of data from the sensor device 20. In another embodiment, the sensor device 20 may be configured to begin transmissions once it receives a confirmation that the display device 30 is within range of the sensor device 20. In other embodiments where communications between the sensor device 20 and the display device 30 are made with a wired connection, communications only occur when the wired connection is established between the sensor device 20 and the display device 30.

The activity data transmitted to the display device 30 is processed to determine one or more personal metrics for the user. As noted above, any of various personal metrics may be presented depending on the activity data collected by the sensor device 20. For example, the personal metrics may include, for example, heart rates, awake times, sleep times, total steps, intensity level, sleep quality, calories spent, etc. The personal metrics may provide instantaneous activity information (e.g., current heart rate) or activity information determined over a given period of time (e.g., average heart rate). If the activity data indicates that the user is walking or running, the appropriate processor 27 or 37 may determine that the user is participating in a high intensity awake activity. On the other hand, if the activity data indicates that the user is sitting or generally sedentary, the appropriate processor 27 or 37 may determine that the user is participating in a lower level awake activity. In at least one embodiment, the activity data may indicate that the user is sleeping or has retired to bed for an evening. In another embodiment, the user may indicate on the sensor device 20 or on the display device 30 that he or she has retired to bed (e.g., by making an appropriate selection on the device 20 or 30). During these times, the appropriate processor 27 or 37 may determine a quality of sleep of the user by determining activity levels during sleep. Relatively low movement during sleep may indicate deeper sleep levels and significant movement during sleep may indicate lighter sleep or even additional awake times. When the user awakens the following morning, the appropriate processor 27 or 37 may automatically determine based on the activity signals that the user has awakened from his or her sleep and is participating in activities of various intensities.

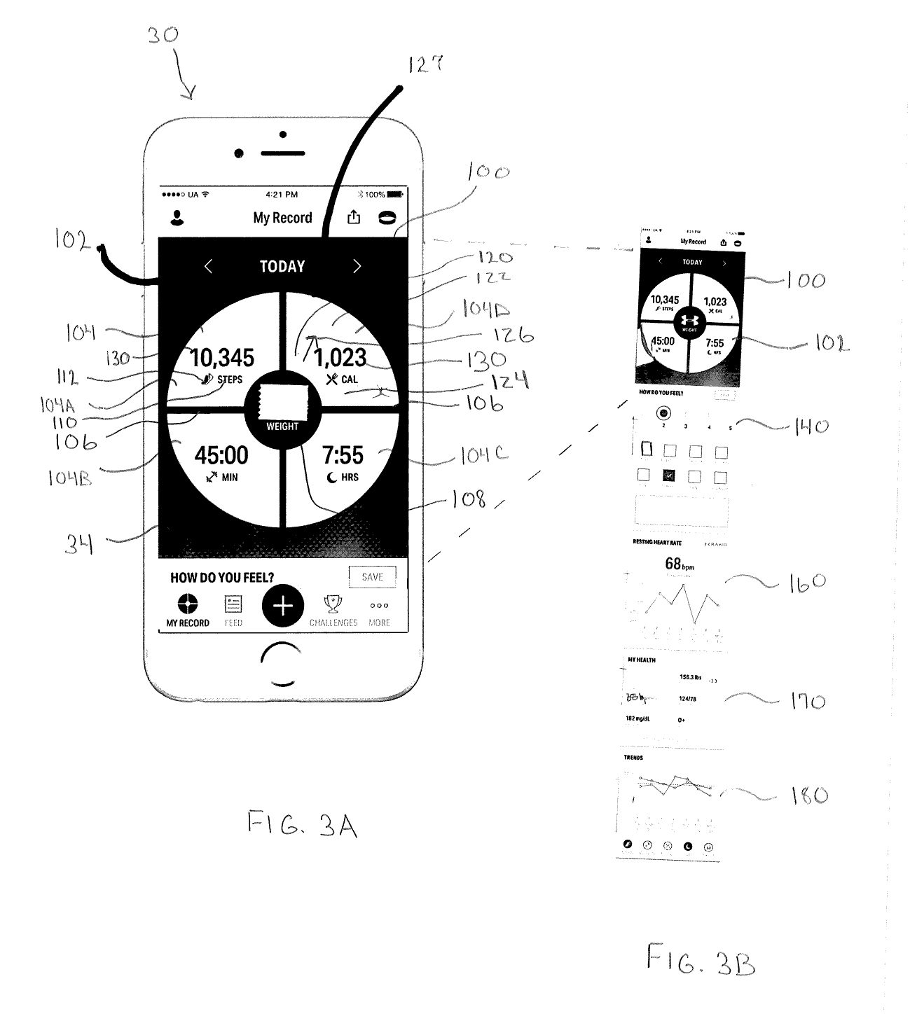

After the activity data is processed to determine one or more personal metrics for the user, the processor 37 may further process the activity data in order to present the activity data in a format for quickly and easily communicating the collected activity data to the user. To this end, the processor is configured to communicate with the I/O interface 36 and display the processed activity information on the screen 34 for viewing by the user. Various formats in which the personal metrics are presented to the user via the display are described in further detail below with reference to FIGS. 3A-11.

Display of Goal-Based Activity Data in Sector Form

With reference now to FIG. 3A, a display device 30 is shown in the form of a mobile telephone. The display device 30 includes a screen 34 configured to display the processed activity data obtained from the sensor device 20 or input manually by the user. The activity data on the screen 34 is processed and displayed using an activity tracking app stored in a computer readable medium such as the memory 38 of the display device 30. The processor 37 of the display device is configured to process the instructions for the app and provide a graphical user interface, including various screens disclosed herein with reference to FIGS. 3A-15.

FIG. 3A shows a dashboard screen 100 for the user. The dashboard screen 100 provides the user with a brief overview of activity data for a period of time, such as a day. The dashboard screen 100 also serves as an entry point for the user to obtain more detailed information concerning various activity data provided on the dashboard screen. In the embodiment disclosed herein, the dashboard screen 100 serves as the home screen for the activity tracking app.

As shown in FIG. 3A, the dashboard screen 100 includes a chart 102 in the form of a wheel divided into a plurality of sectors 104, including sectors 104A-104D. The sectors 104 in the embodiment of FIG. 3A are circular sectors, each sector provided as a quadrant of the wheel. Each sector 104 is positioned between two adjacent sectors (e.g., sector 104B is positioned between adjacent sector 104A and 104C). Linear gaps 106 divide each of the adjacent sectors 104. A central hub 108 is provided at the center of the chart 102, and each of the linear gaps 106 extends radially away from the central hub 108. The central hub 108 may display additional data related to the user or a link to such additional data, such as a user weight, heart rate, profile data, or other data related to or of interest to the user.

Each sector 104 of the wheel is associated with an activity parameter and displays a personal metric 130 for the user. In the embodiment of FIG. 3A, sector 104A is associated with steps for the day, sector 104B is associated with active minutes for the day, sector 104C is associated with sleep time for the day, and sector 104D is associated with calories consumed for the day. The activity parameter associated with each sector 104 may be displayed in one or more ways. For example, the “steps” activity parameter in sector 104A is represented with both text 110 (i.e., “steps”) and an icon 112 (i.e., the shoe icon). In at least one embodiment, each of the different sectors 104 is represented on the chart by a different color to further illustrate that each sector is associated with a different activity parameter (e.g., sector 104A may be a different color from each of sectors 104B, 104C and 104D).

As noted above, a personal metric 130 is also displayed in association with each sector 104. In the embodiment of FIG. 3A, the user's personal metric 130 for sector 104A is “10,345” steps, the user's personal metric for sector 104B is “45:00” active minutes (i.e., forty-five active minutes), the user's personal metric for sector 104C is “7:55” hours of sleep (i.e., seven hours and fifty-five minutes of sleep), and the user's personal metric for sector 104D is “1,023” calories consumed.

In addition to expressing the personal metric 130 for each sector 104 in raw numerical form, the personal metric for each sector may also (or alternatively) be expressed in other forms. For example, the personal metric may be expressed numerically or graphically as a progress toward a goal (which goal may be defined in different ways, such as a desire to exceed some value for a particular activity parameter or fall short of some value for another activity parameter). This progress may be shown in different ways, such as numerically as a fraction or a percentage of the goal. Alternatively, this progress may be shown graphically.

In the embodiment of FIG. 3A, the personal metric is expressed both numerically and also graphically as progress toward a goal. In particular, as can be seen with reference to sector 104D of FIG. 3A, the sector 104D is split into a first section 120 and a second section 122. The first section 120 has a first color, and the second section 122 has a second color that is different from the first color (e.g., the first section 120 may be white while the second section 122 may have a significant gray tint). A boundary 124 exists between the first section 120 and the second section 122. This boundary 124 is may be provided by a defined line or may simply be represented by the color transition between the first section 120 and the second section. The entire sector 104D represents the user's goal for the activity parameter for the day (e.g., consume less than 3,000 calories). The area of the first section 120 represents the user's progress toward the user's goal for the day. The numerical value “1,023” in the sector 104D displays the personal metric toward that goal at the time. The area in the second section 122 represents what remains for the user to achieve the goal. In this case, if the user's goal is to consume less than 3,000 calories for the day, the user's progress is 1,023 calories consumed, which is about ⅓ of the way to the goal. Accordingly, the first section 120 extends outwardly from the central hub 108 about ⅓ of the distance to the outer perimeter edge 127. Alternatively, the first section 120 may be shown as filling about ⅓ of the total area of the sector 104D.

With continued reference to sector 104D of FIG. 3A, as additional calories are consumed by the user, the area of the first section 120 is increased, and the area of the second section 122 is decreased. In other words, for each additional calorie consumption logged by the user, the boundary 124 between the first section 120 and the second section 122 moves radially outward from the central hub 108 in the direction of arrow 126, indicating progress toward a goal. In this manner, the sectors 104 of the chart 102 provide personal metrics as not only raw numerical data but also graphically as progress toward a goal. While progress toward a goal has been described in FIG. 3A by the boundary 124 moving in the direction of arrow 126, it will be appreciated that the boundary may also move in a different manner, such as toward the central hub 108. As another example, the boundary 124 may be radially-oriented and may move in a circumferential direction (instead of a circumferential boundary moving in a radial direction as shown in FIG. 3A).

While sector 104D shows an example of a goal where the user wishes to fall short of some measurement for an activity parameter, it will be recognized that in other sectors, the user's goal may be to surpass a measurement for the activity parameter. For example, sector in 104A, the user's goal may be to surpass 14,000 steps for the day, and the user has logged over ⅔ of the steps necessary to achieving that goal. As another example, in sector 104B, the user's goal may be two hours of physical activity for the day, and the user has yet to log half the time required to achieve that goal. As yet another example, in sector 104C, the user's goal for the day may have been to obtain seven and a half hours of sleep, and the user achieved that goal overnight. Because the user achieved the goal illustrated in sector 104C, the sector is completely one color (i.e., white), indicating that the goal has been achieved.

As described above, the activity data obtained by the sensor device 20 for the user is provided in sector form on the dashboard screen 100. In particular, the dashboard screen 100 includes a chart 102 that is divided into a number of sectors 104, each of the sectors 104 representing an activity parameter. While the chart 102 is a circular or pie-chart in the embodiment of FIG. 3A, it will be recognized that the chart may be provided in other forms. For example, the chart may be provided as a square chart, oval chart, rectangular chart, or in any of various other shapes with any of various sizes. Similarly, while the sectors 104 in the embodiment of FIG. 3A are shown as circular sectors, it will be recognized that the sectors 104 may be provided in different forms. For example, the sectors may be provided on a square chart and the quadrants may be defined by triangular shapes, square shapes. Additionally, while the sectors are disclosed in the embodiment of FIG. 3A as being quadrants, it will be recognized that the sectors may also be different portions of the associated chart. For example, the sectors may define sextants or octants within the chart. Accordingly, it will be recognized that FIG. 3A shows but one exemplary representation of activity data provided in sector form, and numerous variations of the display of activity data in sector form are possible and contemplated herein.

With reference now to FIG. 3B, the chart 102 showing activity data in sector form is one portion of the dashboard screen 100 of the display device 30. The dashboard screen 100 also includes a number of additional charts and data sections. In particular, the dashboard screen includes a health perception section 140 under the “How Do You Feel” heading, a heart rate chart 160 under the “Heart Rate” heading, a vital statistics chart 170 under the “My Health” heading, and a trends chart 180 under the “Trends” heading. The user may scroll to any of these charts or data sections by touching the display screen 34 of the display device 30 with his or her finger and moving along the dashboard screen 100.

Health Perception Section

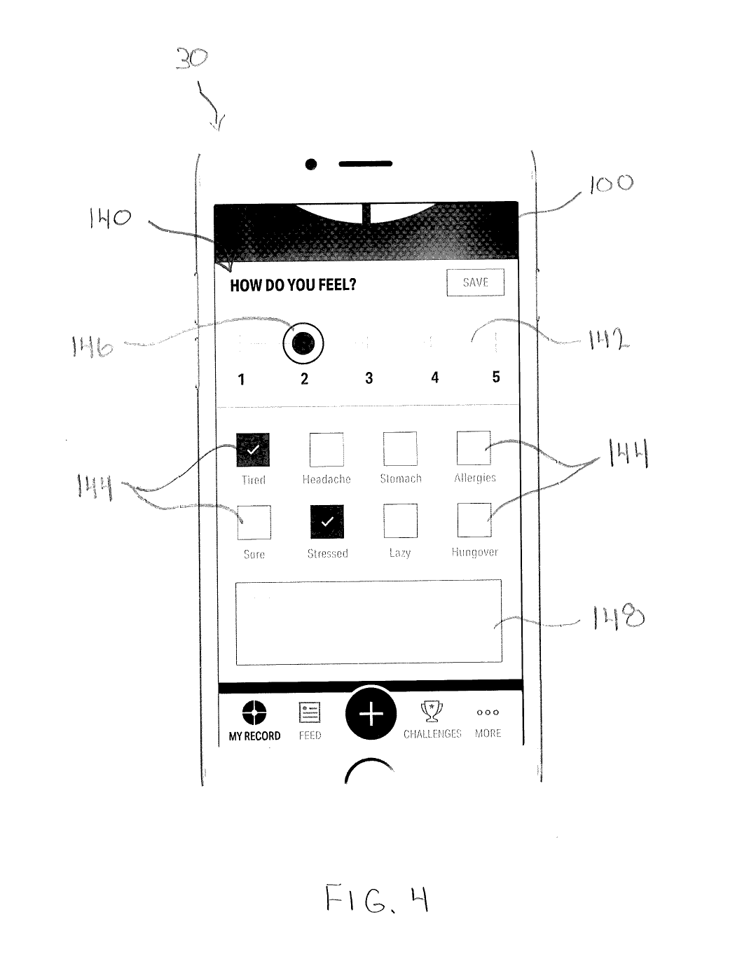

With reference now to FIG. 4, the health perception section 140 of the dashboard includes a sliding scale 142 and a number of detail boxes 144. The sliding scale 142 allows the user to touch a marker 146 on the screen and move the marker between a low number (e.g., “1”) indicating that the user does not feel well, and a high number (e.g., 5) indicating that the user feels very well. In at least one embodiment, when the user slides the marker 146 below a threshold (e.g., any number below “3”) the detail boxes 144 appear, allowing the user to provide input on why he or she does not feel well. The detail boxes 144 are each associated with a perceived physiological condition related to health, wellness or feelings (e.g., tired, headache, stomach, allergies, muscle soreness, stress, lazy feeling, hung-over, etc.). The detail boxes 144 are toggle boxes allowing the user to touch the box and mark that the condition is perceived by the user as a factor in his or her overall health at the time. The user may enter additional comments in the notes box 148, such as further detail about the reason for checking one of the detail boxes. The notes box 148 may also be useful if none of the detail boxes 144 apply. In at least one embodiment, the detail boxes change depending on the number selected by the user on the sliding scale 142. For example, if a number below three is chosen, the detail boxes of FIG. 4 may be displayed; if a number of three or greater is chosen, the displayed detail boxes may be associated with different physiological conditions that may be perceived by the user (e.g., energetic, happy, rested, relaxed, strong, etc.). In at least one embodiment, the detail boxes associated with a perceived physiological condition are different depending on the number selected, however some of the detail boxes may be associated with more than one number (e.g., the “tired” detail box may be associated with each of numbers 1-3, and the “relaxed” detail box may be associated with each of numbers 3-5). Accordingly, one embodiment of the health perception section 140 of the dashboard screen 100 is shown in FIG. 4, it will be appreciated that various embodiments of the health perception section 140 are possible.

Additional Charts on Dashboard Screen

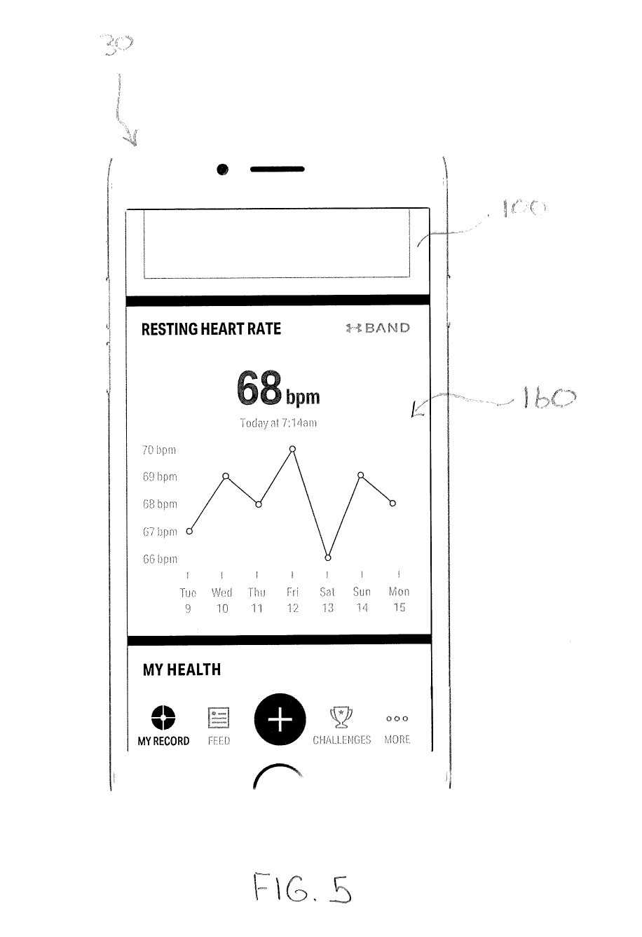

In addition to the chart 102 that provides activity data in sector form and the health perception section 140, the dashboard screen 100 also includes a heart rate chart 160, a vital statistics chart 170, and a trends chart. The heart rate chart is shown in FIG. 5 and allows the user to view activity data related to his or her heart rate. In the example of FIG. 5, a current resting heart rate (i.e., 68 bpm) is shown on the heart rate chart along with average resting heart rates for a number of past days or weeks. However, other heart rate data may also be shown in the chart 160, such as average heart rate for the day or previous days, maximum heart rate, wake-time heart rate, or heart rate trends.

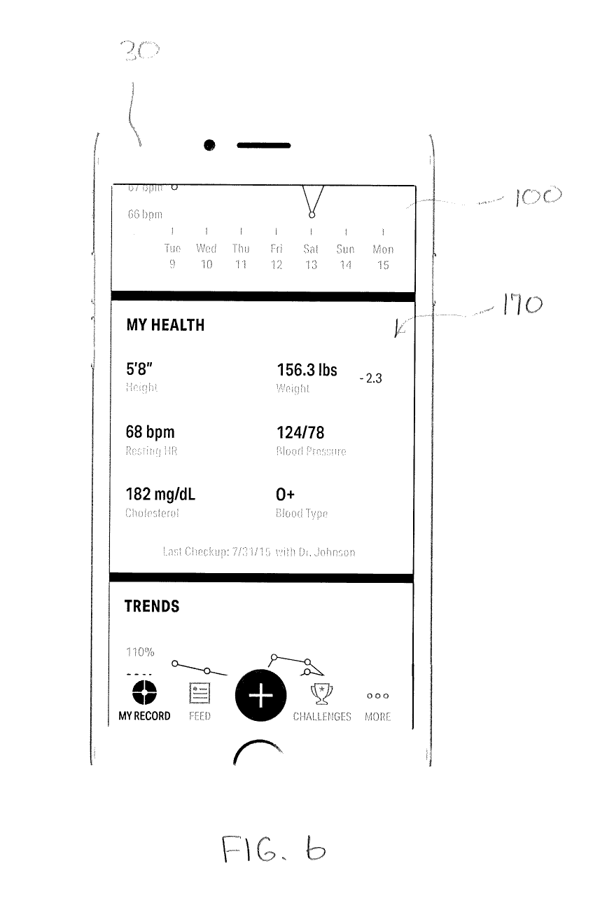

FIG. 6 shows the vital statistics chart 170 for the dashboard screen 100. The vital statistics chart 170 allows the user to quickly view various data points related to his or her overall health. Examples of such information that may be provided on the vital statistics chart include height, weight, average resting heart rate, blood pressure, cholesterol, blood type, recent doctor visits, etc.

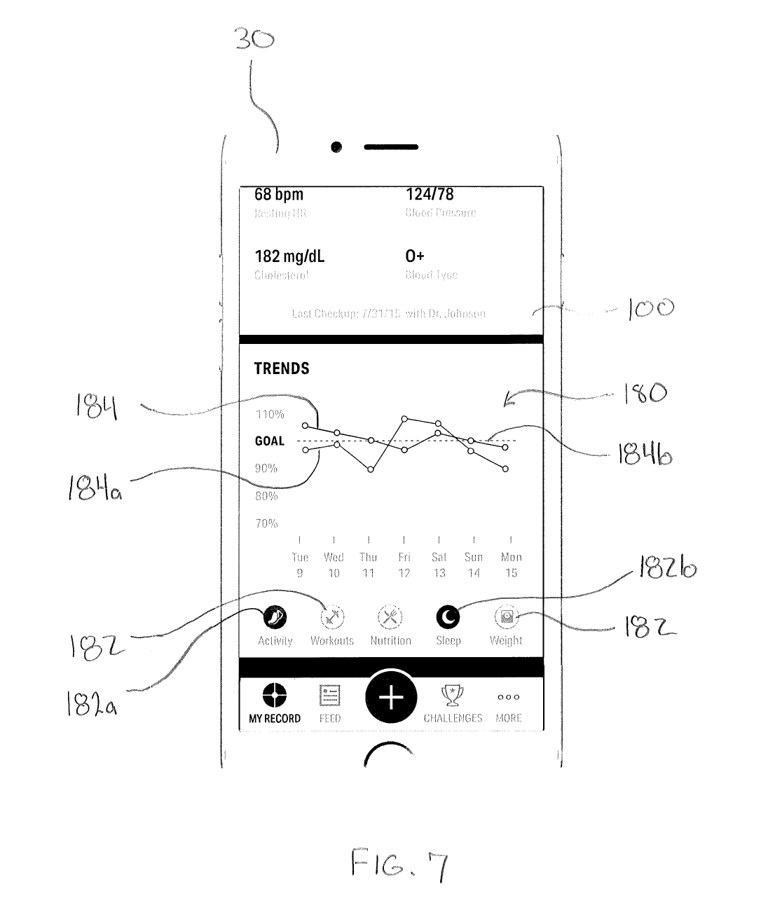

FIG. 7 shows the trends chart 180 for the dashboard screen 100. The trends chart 180 allows the user to quickly view whether he or she has achieved daily or weekly goals over some period of time for some activity parameter. In the embodiment of FIG. 7, the trends chart 180 includes a number of activity parameter icons 182 along the bottom of the chart. When the user selects one of these activity parameter icons 182, an associated trend line 184 will appear on the chart. For example, if the user selects the “activity” icon 182a, an associated “activity” trend line 184a will appear on the chart. The trend line 184 shows the user whether he or she has met the goal for the selected activity over some period of days or weeks. The personal metric in this case is displayed as a percentage of the goal. For example, if the “activity” goal is a number of steps for the day (e.g., 10,000 steps), the trend line will show whether the user has met the goal for the period of time shown on the chart. In the case of trend line 184a, the user came very close to the goal, but just short of the goal on the 9^{th}, 10^{th}, 11^{th}, 14^{th} and 15^{th}. The user exceeded the goal on the 12^{th} and 13^{th}. The selected trend line 184a may also be shown with other trend lines selected by the user. In the embodiment of FIG. 7, the user has selected the sleep icon 182b, and the trend line 184b showing the personal metric associated with sleep is also provided in the chart 180.

Sector Chart as Link to Additional Activity Data

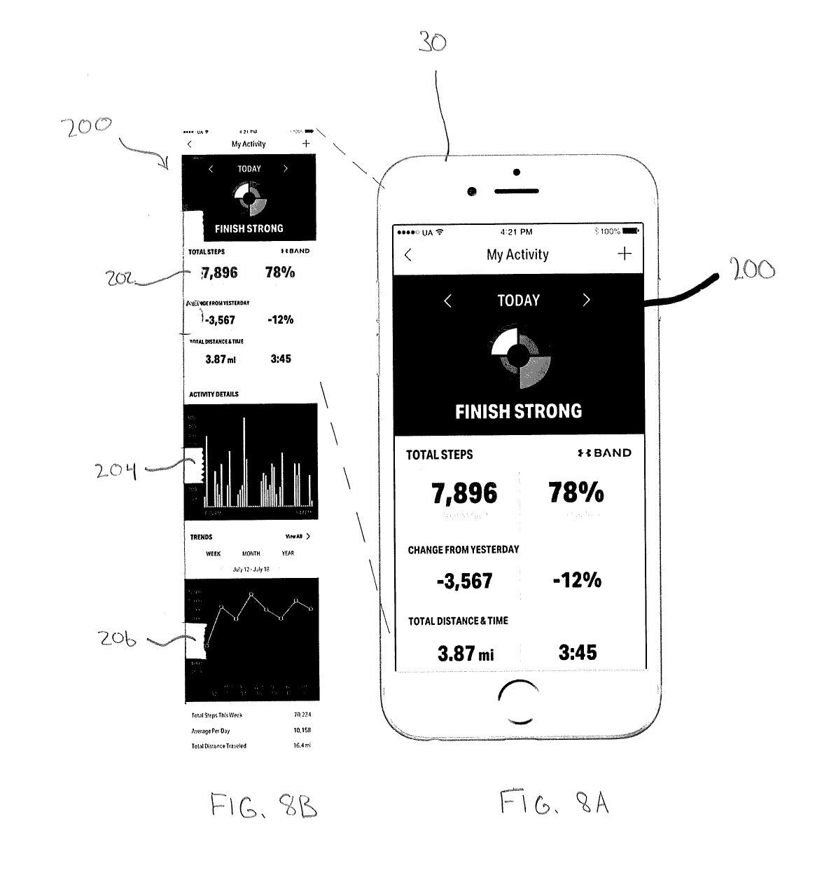

With reference again to FIG. 3A, the user may select any of the sectors 104 on the chart 102 (e.g., by tapping the sector on the screen or otherwise selecting the sector with an I/O device such as a mouse or touch pad). When the user selects one of the sectors, an additional page appears on the display screen 34 providing further detail on the personal metrics associated with the selected sector 104. For example, with reference to FIGS. 8A and 8B, the user selected the “steps” sector 104A from the chart 102, resulting in the steps detail page 200 being presented on the display screen 34 of the display device 30 under the heading “My Activity”. The steps detail page 200 provides the user with a number of blocks providing data points, charts, and statistics related to his or her activity over some period of time (e.g., daily, weekly, monthly, yearly, etc.). For example, in the embodiment of FIGS. 8A and 8B, the first block 202 of the steps detail page provides the user with a personal metric number providing the total number of steps for the day, as well as progress toward the goal (expressed as a percentage calculated by dividing steps completed by the goal). In addition, the first block 202 also provides the user with a change in steps from the same time yesterday (i.e., a difference in steps at this time today vs. yesterday), and a total distance traversed with steps and time spent taking steps today. In addition to the first block 202, a second block 204 provides a chart of total steps taken for each of a number of periods of time (e.g., a past number of days, weeks or months). Also, a third block 206 provides a trends chart showing total steps within a period of time (e.g., a week), average steps over the period of time (e.g., average steps per day), and total distance travelled for the period of time.

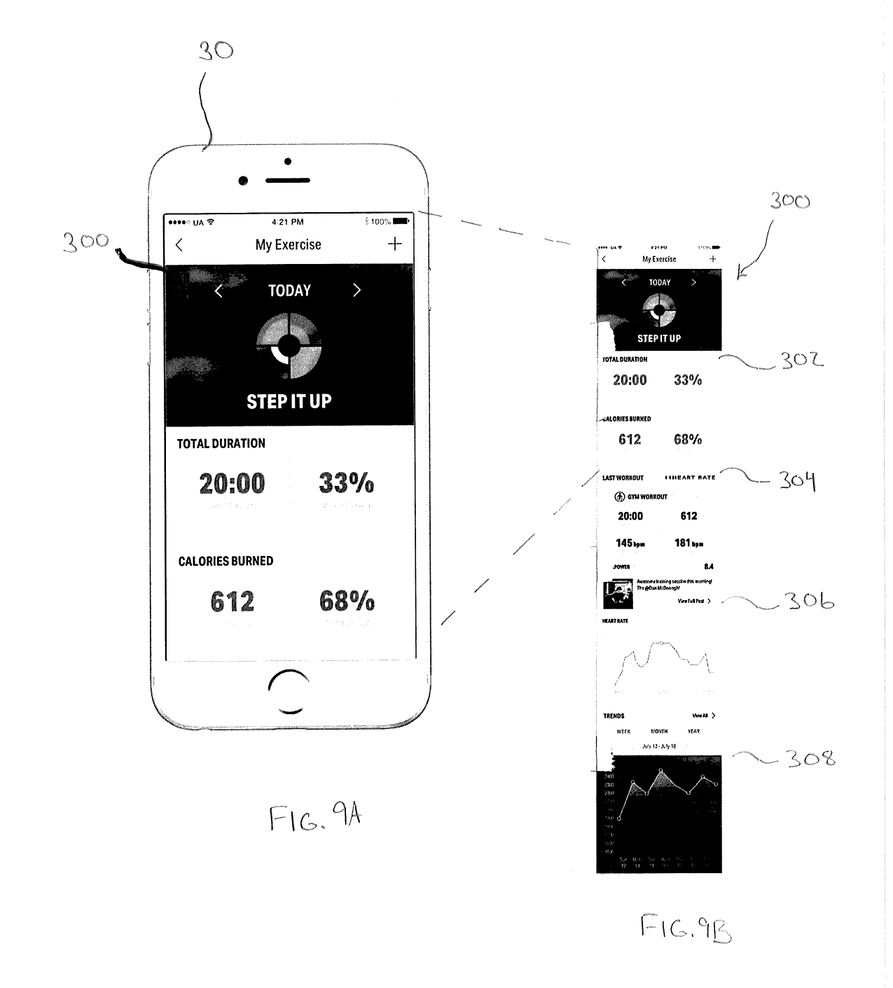

FIGS. 9A and 9B show an exercise detail page 300 presented on the display screen 34 when the user selects the second sector 104B from the chart 102 of FIG. 3A. As shown in FIG. 9A, the exercise detail page 300 provides the user with a number of blocks providing data points, charts, and statistics related to his or her exercise over some period of time (e.g., daily, weekly, monthly, yearly, etc.). For example, in the embodiment of FIGS. 9A and 9B, the first block 302 of the exercise detail page 300 provides the user with a personal metric number providing the total time spent exercising for the day, as well as progress toward the goal (expressed as a percentage calculated by dividing exercise time completed by the goal). The first block 302 also provides the user with calories burned for the day along with information from the user's most recent workout. The exercise detail page 300 also includes a second block 304 provides information on the most recent exercise session completed by the user, including calories burned, duration of workout, average heart rate, and maximum heart rate. A third block 306 provides a chart of heart rate data during the most recent workout. A fourth block 308 provides a chart of workout trends by any of day, week, month, year, etc. The workout trends may be expressed in any number of ways such as average heart rate, calorie burn, time of workout, etc.

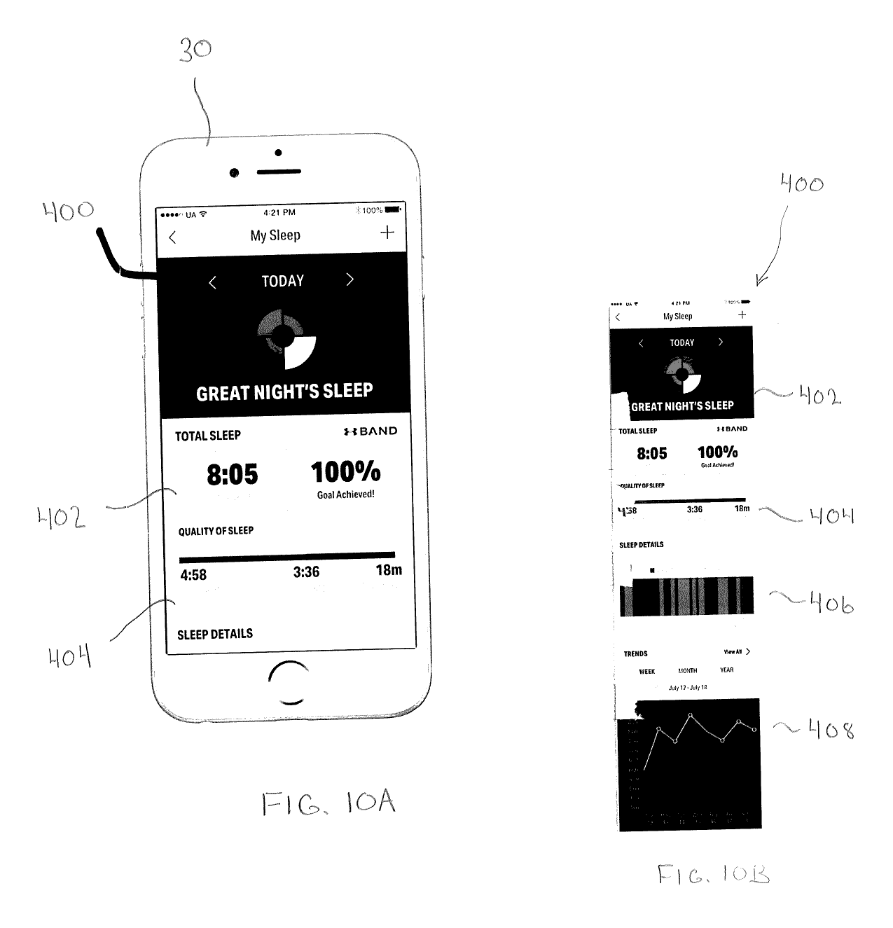

FIGS. 10A and 10B show a sleep detail page 400 presented on the display screen 34 of the display device 30 when the user selects the third sector 104C from the chart 102 of FIG. 3A. As shown in FIG. 10A, the sleep detail page 400 provides the user with a number of blocks providing data points, charts, and statistics related to his or her sleep over some period of time (e.g., daily, weekly, monthly, yearly, etc.). For example, in the embodiment of FIGS. 10A and 10B, the first block 402 of the sleep detail page 400 provides the user with a personal metric number providing the total time spent sleeping for the day, as well as progress toward the goal (expressed as a percentage calculated by dividing the total sleep time for a night by the goal). The second block 404 provides the user with the quality of sleep for the night (expressed as the time of light sleep, deep sleep, and awake time). The third block 406 provides the user with a chart of minute-by-minute details for the night of sleep, with periods of deeper sleep represented as one color and periods of lighter sleep represented as another color. The fourth block 408 provides sleep details over some period of time (e.g., a week or month), allowing the user to see the typical amounts of sleep that he or she received over the period of time.

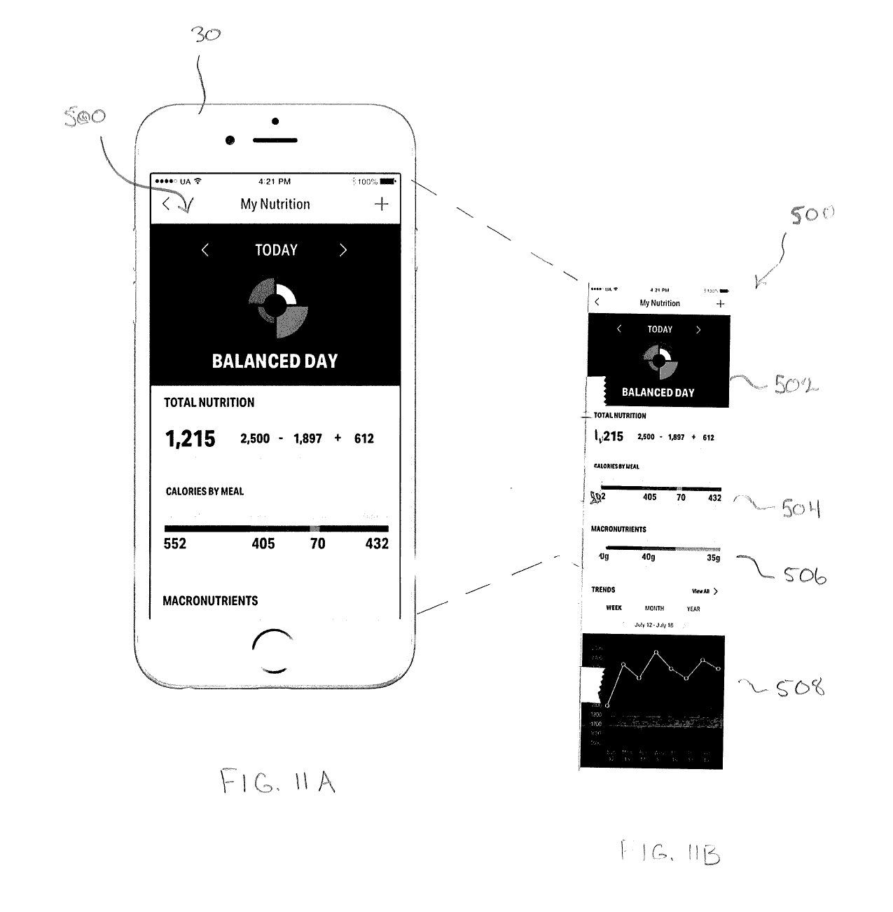

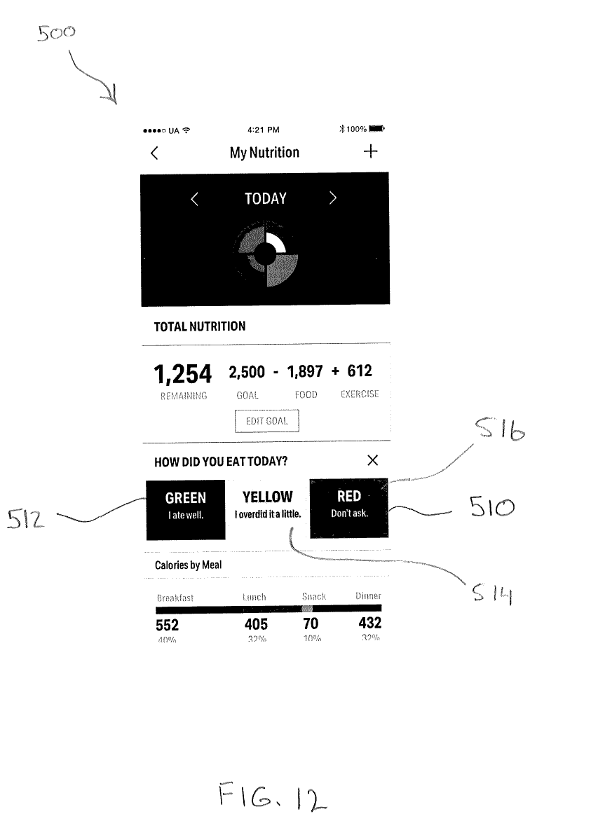

FIGS. 11A-11B show a nutrition detail page 500 presented on the display screen 34 of the display device 30 when the user selects the fourth sector 104D from the chart 102 of FIG. 3A. As shown in FIG. 11A, the nutrition detail page 500 provides the user with a summary of the information he or she has input into the display device 30 concerning food and beverage intake. Various arrangements and methods may be used to facilitate input of nutrition by the user, as explained in further detail below with reference to FIG. 12. As shown in FIG. 11A, the nutrition detail page 500 includes a number of blocks providing data points, charts, and statistics related to nutrition intake over some period of time (e.g., daily, weekly, monthly, yearly, etc.). For example, in the embodiment of FIGS. 11A and 11B, the first block 502 of the nutrition detail page 500 provides the user with a personal metric number providing the total calories consumed for the day along with a number of calories remaining for consumption in order for the user to achieve the goal (e.g., a caloric intake less than a some number). In the embodiment of FIG. 11A, the user's caloric goal is 2,500 calories, the user has already consumed 1,897 calories, but the user has exercised a sufficient amount to add an additional 612 calories to the goal. Accordingly, the user may still consume 1,215 calories and meet his or her goal. The second block 504 provides the user with calories consumed by meal, including breakfast, lunch, snacks and dinner. The third block 506 provides the user with the total of various nutrients consumed for the day, such as total protein, fat and carbohydrates. The fourth block 508 provides the user with nutritional trends, such as the total calories consumed each day for a period of time (e.g., for the past week).

With reference now to FIG. 12, in at least one embodiment, the nutrition detail page 500 includes a consumption estimate block 510 that allows the user to easily enter nutritional information. The consumption estimate block 510 includes three selections that allow the user to indicate how he or she feels about the food they consumed for the day. The three selections include: (i) a first selection 512 indicating that the user ate well for the day, (ii) a second selection 514 indicating that the user ate a bit too much for the day, and (iii) a third selection 516 indicating that the user did not eat well for the day and likely was far beyond the designated calorie goal for the day. In at least one embodiment, the selections are color coded, with the first selection 512 being a green color, the second selection 514 being a yellow color, and the third selection 516 being a red color. When the user makes a selection (e.g., touches one of 512, 514 or 516) a predetermined estimate of the calories and nutrients that may have been consumed during various meals is presented to the user in association with blocks 504 and 506. The user may then adjust these estimates, if desired. Also, in at least one embodiment, the color of the chosen selection 512, 514 or 516 is shown on the associated sector 104D of the chart 102 on the dashboard screen 100. For example, the color of the numerical value of the personal metric 130 displayed in sector 104D may be changed to the same as the chosen color of selection 512, 514 or 516. In any event, the consumption estimate block 510 allows the user to quickly and easily input calories consumed for the day without the need to provide detailed information about each meal. As a result, users are more likely to enter food consumption information, thereby providing additional activity data for use by the system.

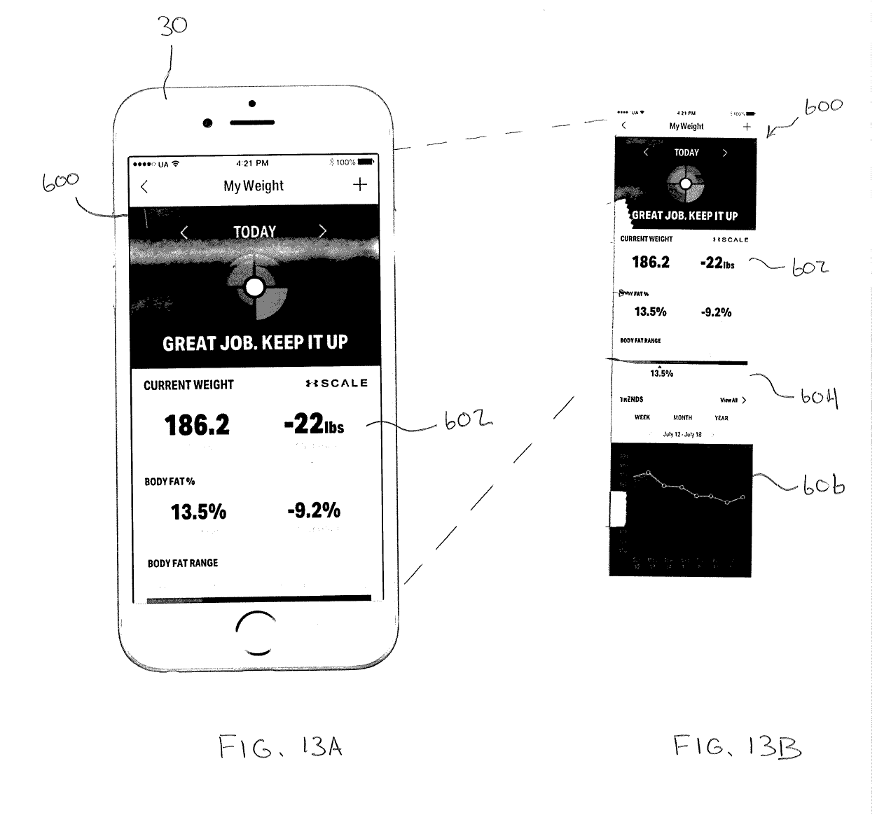

FIG. 13A-13B shows a weight detail page 600 that is presented to the display screen 34 of the display device 30 when the user selects the central hub 108 from the chart 102 of FIG. 3A. As shown in FIG. 13A, the weight detail page 600 provides the user with a summary of recent weight information input by the user. Weight information may be input by the user manually or via an automatic transmission from a scale in wireless communication with the display device 30. As shown in FIG. 13A, the weight detail page 600 includes a number of blocks providing data points, charts, and statistics related to nutrition intake over some period of time (e.g., daily, weekly, monthly, yearly, etc.). For example, in the embodiment of FIGS. 13A and 13B, the first block 602 of the weight detail page 600 provides the user with a personal metric number indicating the user's current weight and body fat percentage. The first block 602 may also indicate how many pounds and body fat percentage needed for the user to reach his or her goal. In a second block 604, the user is presented with a scale showing the user's current body fat percentage in relation to a population range. In a third block 606, the user is presented with trend information related to his or her weight, including the user's weight as measured each day for a period of time (e.g., for the past week, month, year, etc).

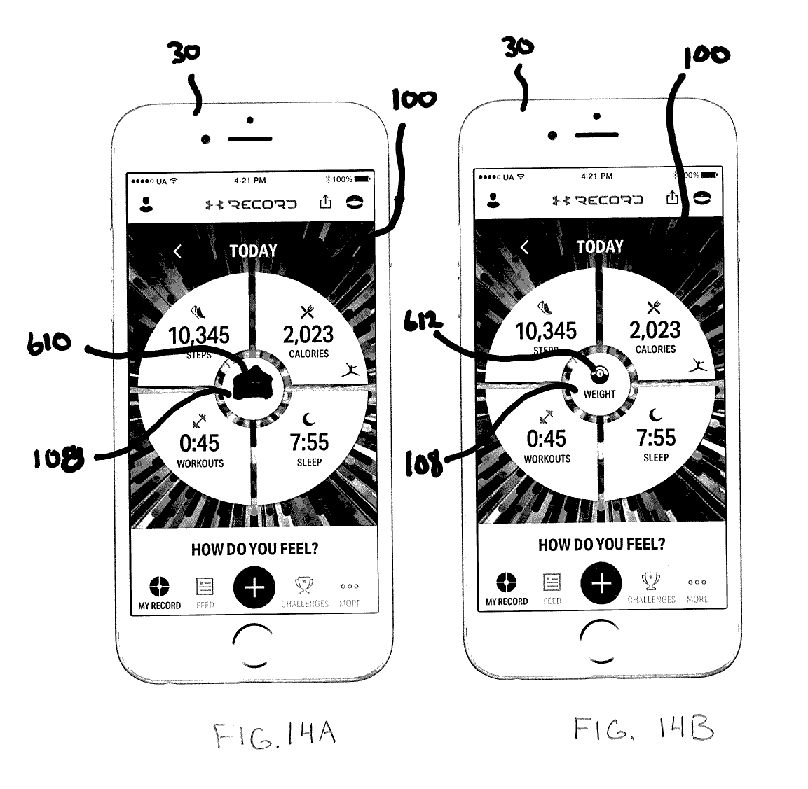

FIGS. 14A and 14B show an alternative embodiment of the chart 102 of the dashboard screen wherein the central hub 108 transitions from a logo 610 (as shown in FIG. 14A) to an icon 612 (as shown in FIG. 14B) providing a link to the weight details page 600. The transition from the logo 610 to the icon 612 may occur at any number of different times. For example, in at least one embodiment, the activity tracking app initially launches with the dashboard screen 100 shown including the logo 610 in the central hub 108, as shown in FIG. 14A. After a predetermined period of time following launch of the app (e.g., after 30 seconds, 1 minute, etc.), the central hub 108 transitions to the icon 612, as shown in FIG. 14B, thus providing a link to the weight details page 600. In at least one embodiment, the transition from the logo 610 to the icon 612 occurs periodically such that the logo 610 is presented to the user for a short amount of time within a given period of time (e.g., five seconds every minute).

Alternative Sector Chart

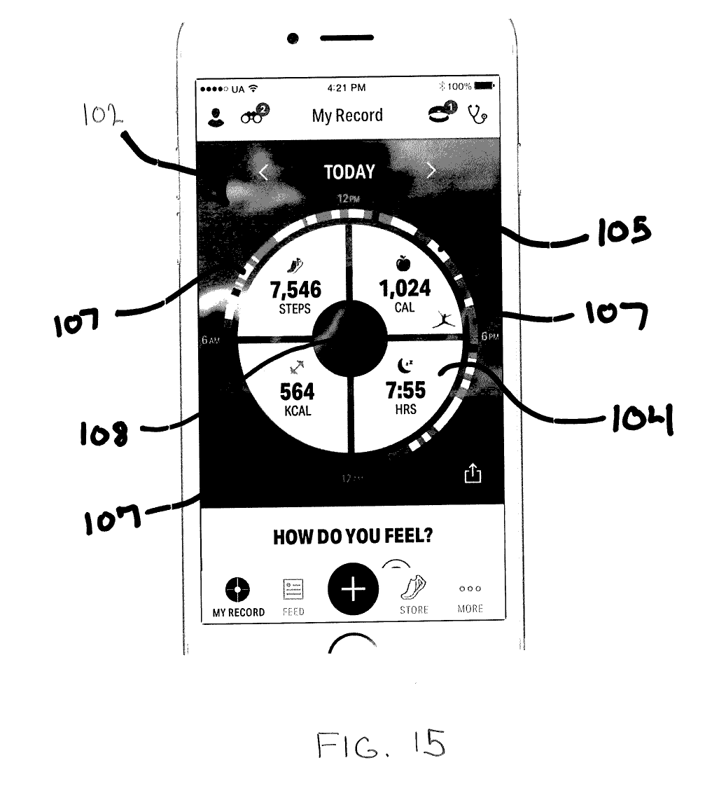

FIG. 15 shows an alternative embodiment of the chart 102 having multiple sectors of FIG. 3A. In this embodiment, the chart also includes an outer activity disk 105 that surrounds each of the sectors 104 of the chart. The outer activity disk 105 provides a summary of the user's activity data for a particular day. The outer activity disk 105 is circular and represents some period of time such as twelve hours or twenty-four hours. Periods of time are represented on the outer activity disk 105 in a clock-like manner. In the exemplary embodiment of FIG. 15, a twenty-four hour period of time is shown with midnight at the bottom of the disk 105 and noon at the top of the disk 105 (i.e., at the twelve-o'clock position). Other times are spaced accordingly along the disk (e.g., 6 pm at the three-o'clock position and 6 am at the nine o'clock position).

Awake time and sleep time activity is represented by a number of outer sectors 107 positioned about the outer activity disc. The outer sectors 107 are provided by arc-like shapes (which may also be referred to herein as “frusto-pie shapes”) of different colors. For example, the outer sectors 107 that represent awake time for the user may be orange, white or green, while the outer sectors 107 that represent sleep time for the user may be blue in color. Different colors or different shades of a color represent different activities. For example, an orange color may represent aerobic activity, a green color may represent weight loss activity, a white color may represent sedentary activity, and a blue color may represent sleep. Darker blue colors may represent periods of deeper sleep than lighter blue colors. The degree of the arc covered by each block 60 or 70 indicates the period of time covered by the block. For example, if the block covers 15° of the 360° circular axis 52 (i.e., 1/24^{th} of the circular axis), the block may be considered to cover a one hour period of time.

Method of Providing Activity Data

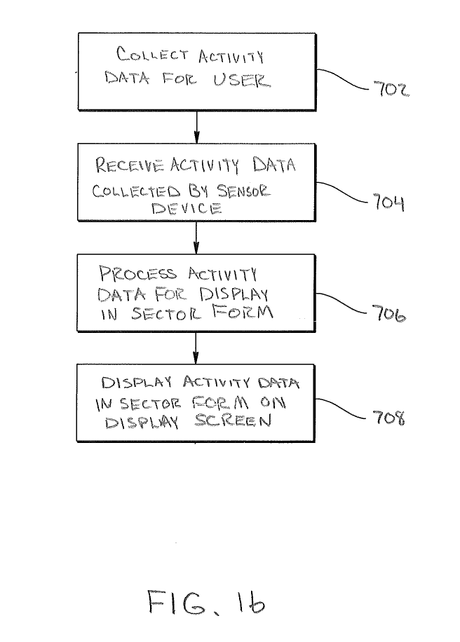

The above described activity tracking system 10, including the activity sensor device 20 and an associated display device 30, is configured to provide a method of delivering activity data to a user. With reference to FIG. 16, in at least one embodiment, the method begins with step 702 with a sensor device carried by a user collecting activity data for the user. Then, in step 704, the activity data collected by the sensor device is transmitted from the sensor device and received by a display device. The activity data provided by the sensor device is processed and associated with at least one of a plurality of personal metrics determined for the user. Additionally, in at least one embodiment, some of the activity data may be manually input into the display device by the user. This activity data manually input by the user is also processed by the display device and associated with another of the plurality of personal metrics. Next, in step 706, the method continues with the display device further processing the activity data received from the sensor device for presentation on a display screen in sector form. Thereafter, in step 708, the activity data received from the sensor device is displayed in sector form on the display screen. When the activity data is displayed on the display screen, each of the plurality of personal metrics is associated with one of a plurality of sectors on the display screen. Additionally, each of the plurality of sectors includes a first area associated with progress toward a goal for the associated personal metric and a second area associated with remaining requirements to reach the goal for the associated personal metric.

The foregoing method may be accomplished with the assistance of a computer program, such as the activity tracking app described above, stored in the memory 38 and executed by the processor 37 of the display device. The above described system and method solves a technological problem common in industry practice related to effective and efficient presentation of activity data to a user. Moreover, the above-described system and method improves the functioning of the computer/device by allowing activity data to be effectively communicated on a single display screen provided by the dashboard screen. The system and method also allows the user to easily view additional data related to several personal metrics using the dashboard screen as a menu for obtaining additional data.

The foregoing detailed description of one or more exemplary embodiments of the activity tracking device and associated display has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed exemplary embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the exemplary embodiments contained herein.

What is claimed is:

1. An activity tracking arrangement configured to provide activity data to a user, the activity tracking arrangement comprising:
a sensor device configured to be carried by the user, the sensor device including at least one sensor configured to obtain activity data for the user; and
a display device including a display screen, the display device configured to receive the activity data obtained by the sensor device, process the activity data obtained by the sensor device into at least one personal metric of a plurality of personal metrics for the user, and display the plurality of personal metrics for the user on a chart on the display screen, wherein each of the plurality of personal metrics for the user is associated with one of a plurality of sectors on the chart, and wherein each of the plurality of sectors includes a first area associated with progress toward a goal for an associated personal metric and a second area associated with remaining requirements to reach the goal for the associated personal metric.

2. The activity tracking arrangement of claim 1, wherein the chart is a wheel and each the plurality of sectors on the display screen are circular sectors.

3. The activity tracking arrangement of claim 2 wherein each of the circular sectors is a quadrant.

4. The activity tracking arrangement of claim 1 wherein each of the plurality of sectors on the chart is separated from an adjacent sector on the chart by a linear gap.

5. The activity tracking arrangement of claim 4 further comprising a central hub, each linear gap extending radially from the central hub.

6. The activity tracking arrangement of claim 1 wherein the plurality of personal metrics include total steps, calories consumed, calories spent, and time of sleep.

7. The activity tracking arrangement of claim 1 wherein the sensor device is a fitness tracker configured to determine steps taken by the user or a heart rate of the user.

8. The activity tracking device of claim 1 wherein the at least one personal metric is at least one first personal metric, and wherein the display device is further configured to receive activity data input manually by the user, process the activity data input manually by the user into at least one second personal metric of the plurality of personal metrics, and associate the at least one second personal metric with another of the plurality of sectors on the chart.

9. A non-transient computer readable medium containing instructions for controlling a display device by:
receiving activity data from a sensor device carried by a user, the activity data associated with at least one of a plurality of personal metrics;
processing the activity data received from the sensor device for presentation on a display screen in sector form; and
displaying the processed activity data in sector form on the display screen, wherein each of the plurality of personal metrics is associated with one of a plurality of sectors on the display screen, and wherein each of the plurality of sectors includes a first area associated with progress toward a goal for an associated personal metric and a second area associated with remaining requirements to reach the goal for the associated personal metric.

10. The computer readable medium of claim 9, wherein the plurality of sectors on the display screen are circular sectors.

11. The computer readable medium of claim 10 wherein each of the circular sectors is a quadrant.

12. The computer readable medium of claim 9 wherein each sector on the display screen is separated from an adjacent sector on the display screen by a linear gap.

13. The computer readable medium of claim 12 further comprising a central hub, each linear gap extending radially from the central hub.

14. The computer readable medium of claim 9 wherein the plurality of personal metrics include total steps, active minutes, calories consumed, and time of sleep.

15. The computer readable medium of claim 9 wherein the sensor device is configured to determine steps taken by the user or a heart rate of the user.

16. The computer readable medium of claim 9 further comprising receiving activity data input manually by the user, the activity data input manually by the user associated with a second of the plurality of personal metrics.

17. A method of providing activity data to a user, the method comprising:
receiving activity data from a sensor device carried by a user, the activity data associated with at least one of a plurality of personal metrics;
processing the activity data received from the sensor device for presentation on a display screen in sector form; and
displaying the activity data received from the sensor device in sector form on the display screen, wherein each of the plurality of personal metrics is associated with one of a plurality of sectors on the display screen, and wherein each of the plurality of sectors includes a first area associated with progress toward a goal for an associated personal metric and a second area associated with remaining requirements to reach the goal for the associated personal metric.

18. The method of claim 17 further comprising receiving a goal input at a display device including the display screen, the goal input defining the goal for the associated personal metric.

19. The method claim 17 wherein each the plurality of sectors on the display screen are circular sectors and each of the circular sectors is a quadrant.

20. The method of claim 17 wherein each sector on the display screen is separated from an adjacent sector on the display screen by a linear gap, each linear gap extending radially from a central hub.

21. The method of claim 17 wherein the plurality of personal metrics include total steps, calories consumed, active minutes, and time of sleep.

22. The method of claim 17 wherein the sensor device is configured to determine steps taken by the user or a heart rate of the user.

23. The method of claim 17 further comprising receiving activity data input manually by the user, the activity data input manually by the user associated with a second of the plurality of personal metrics.
